(19) United States
(12) Patent Application Publication
(10) Pub. No.: US 2020/0051038 A1
(43) Pub. Date: Feb. 13, 2020

(54) CALIBRATION OF CLOUD-BASED INFORMATION FOR LIFETIME PREDICTION OF LUMINAIRES

(71) Applicant: SIGNIFY HOLDING B.V., EINDHOVEN (NL)

(72) Inventors: HARRY BROERS, 'S-HERTOGENBOSCH (NL); RUBEN RAJAGOPALAN, NEUSS (DE); WEI PIEN LEE, EINDHOVEN (NL); PIERLUIGI CASALE, EINDHOVEN (NL); JAN EKKEL, OSS (NL)

(21) Appl. No.: 16/498,852

(22) PCT Filed: Mar. 23, 2018
(86) PCT No.: PCT/EP2018/057500

§ 371 Date: Sep. 27, 2019

(30) Foreign Application Priority Data
Mar. 28, 2017 (EP) 17163194.8

(51) Int. Cl. G06Q 10/00; H05B 33/08; H05B 37/02; H05B 37/03; G01N 25/00; G06N 20/00

(52) U.S. Cl. CPC G06Q 10/20; H05B 33/0893; G06N 20/00; H05B 37/03; G01N 25/00; H05B 37/0227

(57) ABSTRACT

The described embodiments relate to systems, methods, and apparatuses for estimating luminaire lifetimes using extrapolated sensor data. During a lifetime of a luminaire (108), a sensor (206) of the luminaire can become inoperable well before the entire luminaire becomes inoperable. In order to estimate when the luminaire will become inoperable, sensor data (504) should be continually tracked even after the sensor fails. In order to continue obtaining sensor data after the sensor fails, the sensor data can be extrapolated based on a correlation between previously received sensor data and other environmental data. The extrapolated sensor data can be tracked after the sensor becomes inoperable so that estimates of luminaire lifetime can be more accurate, compared to not having any sensor data. In this way, maintenance of luminaires can be scheduled according to predictions of luminaire lifetimes, rather than the occurrence of a luminaire failure.

### TECHNICAL FIELD

The described embodiments generally relate to predicting lifetimes of luminaire components. More particularly, the embodiments relate to systems, methods, and apparatuses for correlating cloud-based information with local sensor data to predict lifetimes of luminaire components.

### BACKGROUND

Large lighting systems such as outdoor lighting systems that extend over large geographic areas can prove difficult to maintain because unpredictable malfunctions can occur at any portion of the system. Furthermore, when a malfunction does occur, scheduling and performing repairs can be time consuming when maintenance crews must travel to distant locations to reach a problematic luminaire. Although maintenance of a single luminaire (and its constituent components) may not be complicated to undertake, oftentimes, groups of luminaires can fail unpredictably as a result of the luminaires being exposed to similar environmental conditions over their lifetime. Such unpredictable group failures can make the task of performing repairs exceedingly daunting.

### SUMMARY

The present disclosure is directed to systems, methods, and apparatuses for using extrapolated sensor data to predict luminaire component lifetimes. In some embodiments, a method is set forth for extrapolating data after a sensor of a device ceases to provide data. The method can include steps of receiving first data from the sensor of the device and receiving second data from a remote device. The second data can correspond to measurements associated with an operational environment of the device. The method can also include generating, subsequent to the sensor ceasing to provide data, extrapolated data based on a correlation between the first data and the second data. The extrapolated data can be generated according to a machine learning algorithm. The machine learning algorithm can be used to derive a correlation function. In some embodiments, generating the extrapolated data can include providing the second data as an input to the correlation function, which outputs the extrapolated data in response to receiving the second data. The machine learning algorithm can include a step of generating a decision tree for categorizing the first data received from the sensor. The method can also include a step of determining an estimated lifetime for the device based at least on the extrapolated data. Determining the estimated lifetime for the device can include comparing the extrapolated data to collected data that is associated with a different device that was previously rendered inoperable. Determining the estimated lifetime for the device can include determining an amount of the time the device has been operational, and identifying a type of device failure that is associated with the amount of time. The embedded sensor can be a temperature sensor, the extrapolated data can be predicted temperature data, and the estimated lifetime for the device can be determined at least partially based on a number of temperature cycles experienced by the device as indicated by the predicted temperature data. The extrapolated data can be generated prior to the sensor ceasing to provide the first data, and the sensor can be temporarily shutdown to stop the sensor from providing the first data.

In other embodiments, a lighting management system is set forth. The lighting management system can include a luminaire that includes a sensor for measuring an operating condition of the luminaire. The lighting management system can also include a memory configured to store sensor data received from the sensor of the luminaire and environmental data received from a remote device that tracks environmental conditions associated with the luminaire. The lighting management system can further include a processor in communications with the luminaire and the memory. The processor can be configured to identify a correlation between the sensor data and the environmental data, and generate extrapolated sensor data for storage in the memory after the sensor ceases to provide the sensor data. The processor can be further configured to determine an estimated lifetime of one or more components of the luminaire using at least the extrapolated sensor data. Moreover, the processor can be configured to identify the correlation using a machine learning algorithm that involves pre-processing the environmental data for identifying statistical features of the environmental data. The sensor can be a temperature sensor that measures an internal temperature of the luminaire, and the environmental data can correspond to an external temperature of the luminaire. In some embodiments, the environmental data can correspond to an environmental variable having different units than the sensor data. Furthermore, the processor can be configured to use a statistical regression algorithm for identifying the correlation between the sensor data and the environmental data. As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “controller” is used herein generally to describe various apparatus relating to the operation of one or more light sources. A controller can be implemented in numerous ways (e.g., such as with dedicated hardware) to perform various functions discussed herein. A “processor” is one example of a controller, which employs one or more microprocessors that may be programmed using software (e.g., machine code) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or machine code) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g., for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “lifetime” as used herein can refer to an amount of time a device is operational within a specification for the device. For example, the lifetime of a sensor can be an amount of time the sensor is able to provide accurate sensor data that meets a predetermined specification of accuracy. The lifetime of a luminaire (or one or more components thereof) can be an amount of time the luminaire is able to provide controlled illumination according to a specified control or power input to the luminaire.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a system for communicating data that can be used to develop predictions of luminaire lifetimes.

FIG. 2 illustrates a lighting management system for collecting data related to operations of luminaires and using the data to develop correlation functions for extrapolating sensor data when sensors of the luminaires fail.

FIG. 3 illustrates a lighting management system that uses one or more correlation functions to provide extrapolated sensor data when one or more sensors of the lighting management system has failed.

FIG. 4 illustrates a plot of a variety of variables that can be collected by the remote services discussed herein.

FIG. 5 illustrates a plot of remote temperature data having some correlation to local temperature data measured by a sensor of a diagnostic module of a luminaire.

FIG. 6 illustrates a plot of different failures rates that correspond to different types of failures that can occur at a network of luminaires.

FIG. 7 illustrates a plot that includes time ranges that can be stored at, or otherwise accessible to, a lighting management system.

FIG. 8 illustrates a method for estimating a lifetime of a luminaire based on extrapolated sensor data.

FIG. 9 illustrates a method for estimating a lifetime of a luminaire based on how long the luminaire has been operational.

### DETAILED DESCRIPTION

The described embodiments relate to a systems, methods, and apparatuses for predicting lifetimes of luminaires and/or components thereof using both remote and local sensor data, and extrapolating sensor data when a sensor is no longer able to provide sensor data for a particular service. Outdoor lighting, such as street lighting, can be heavily affected by environmental conditions that can degrade the performance of luminaire components over time and ultimately lead to one or more of the luminaire components (e.g., lamp, power source, etc.) failing. Although maintenance can be performed to repair or replace failed luminaire components, outdoor lighting that extends over a large geographic area, such as a city, can prove difficult to maintain because of the unpredictability of where in the geographic area a luminaire (or a constituent component) will fail.

In order to predict such failures, remote diagnostics and/or data analytics can be used to gather environmental data near the luminaires and related to the operation of the luminaires. Data related to the operation of the luminaires can include luminance levels when one or more luminaires are on, off, and/or operating at a particular dim level. Local data can be gathered by a diagnostic module of one or more luminaires. The diagnostic module can be used to perform a variety of functions such as provide usage data, performance data, data related to factors that influence lifetime such as temperature, and damage event data. The diagnostic module can also be used to schedule maintenance and/or perform reactive maintenance. The diagnostic module can include one or more sensors that collect environmental data and/or operational data that can be analyzed by a lighting management system. In many cases, the sensors tend to have shorter lifetimes than the luminaires (or constituent components of the luminaires). For example, a sensor may be expected to operate for approximately three years and a luminaire lamp might be expected to operate approximately fifteen to thirty years. However, according to some embodiments discussed herein, instead of replacing a sensor when the sensor fails, data collected by the sensor, and thereafter extrapolated, can be used to estimate the lifetime of the luminaire and/or constituent components thereof. In some embodiments, data from a sensor can be extrapolated based on a correlation between the data and other sources. Thereafter, the sensor could be turned off to preserve the life to the sensor, and the extrapolated sensor data could be used to estimate the lifetime of the luminaire (or one or more constituent components thereof) or assist with other services such as lighting control.

A lighting management system for predicting luminaire lifetimes can include a network of luminaires and diagnostic modules in the luminaires for detecting operating conditions of the luminaires. Additionally, the lighting management system can include a cloud service that can provide environmental data related to environmental conditions of the luminaries and a statistical model that is based on the operating conditions and environmental conditions. While a sensor of a diagnostic module is operational, luminaire lifetimes can be predicted and, thereafter, when the sensor has failed, the statistical model can be provided data from the cloud service to continue making predictions about luminaire lifetimes.

Predictions about the lifetime of one or more luminaires connected to a lighting management system can be based on information gathered directly by sensors that are in communication with the luminaires and/or indirectly from a remote device (e.g., a cloud based service, a remote computing device, a drone computing device). Data collected by a cloud based service can include information such as temperature, humidity, wind speeds, sound, vibration, power grid, air quality, and/or any other information suitable for use when predicting lifetimes of devices. While the sensors are operational, sensor data can be calibrated and/or correlated with information from a remote device so that, when the sensors are no longer operational, the information provided by the remote device can be used to extrapolate sensor data and make luminaire lifetime predictions.

The sensor data can include measurements inside and/or near a luminaire, and the sensor data can be stored at the luminaire and/or provided to the remote device for analysis. Frequency of the sensor measurements can therefore be based on an amount of storage available to the luminaire. A lighting management system that connects multiple luminaires in a network can act as an intermediary between the remote device and the network of luminaires. As the remote device gathers information related to external and internal conditions of the luminaires, the remote device can develop a model that can be used to predict the lifetime of one or more luminaires.

The model developed by the remote device can be a statistical model based on one or more variables measured by a sensor of a luminaire and a remote sensor in direct or indirect communication with the remote device. The statistical model can be developed using machine learning tools (e.g., regression techniques such as linear regression, Hidden Markov Model, Recurrent Neural Network, decision tree, random forest) and/or other data analysis/algorithm optimization tools (e.g., lasso (least absolute shrinkage and selection operator) regression and/or stochastic gradient descent for machine learning model optimization). Non-linear mapping tools, such as support vector machines, ensemble learning, and/or deep learning can also be used in order to compensate for factors that can influence external environmental data. One or more of these tools can operate at the remote device, the lighting management system, and/or a luminaire. Furthermore, one or more of the tools can be embodied as a correlation engine that takes in data from a variety of sources and in order to provide one or more correlation functions. A correlation function can thereafter be used to extrapolate sensor data using data related to internal operations of the luminaire and external data related to an environment of the luminaire. Correlation of sensor data with environmental data is used to forecast internal conditions of the luminaire when the sensor data is no longer available as a result of the sensor failing. For example, temperature cycles internal to the luminaire can be tracked while the sensor is operational and, after the sensor has failed, the correlation can be used to extrapolate the sensor data. In some embodiments, the environmental data can correspond to an environmental variable that has different units than the units corresponding to the sensor data. In some embodiments, pre-processing of variables can be employed for optimizing the function that predicts luminaire lifetimes. For example, a mean, standard deviation, skewness, kurtosis, maximum, minimum, range, and/or any suitable metric or combination thereof can be calculated for any variable tracked by a sensor or remote device.

In some embodiments, multiple functions for predicting luminaire lifetimes can be created and ranked according to their ability to accurately predict luminaire lifetimes. Furthermore, functions can be categorized according to the environments and/or the type of luminaires they are best able predict lifetimes for. For example, a function that correlates temperature data can be suitable for predicting luminaire lifetimes for luminaires in a suburb of a particular city, whereas a function that correlates humidity can be more suitable for predicting luminaire lifetimes for luminaires within the particular city.

Once a function has been derived for a luminaire or group of luminaires in a geographic location, service schedules can be developed based on the lifetime predictions made according to the functions. By developing service schedules in this way, resources for performing maintenance can be allocated in a way that saves time and energy when luminaires fail or otherwise malfunction. In some embodiments, lifetime predictions can be used when manufacturing a device, performing maintenance optimization, and identifying products that will fail less in specific environments.

A luminaire can have a variety of failure modes that can be tracked for purposes of predicting luminaire lifetime. Such failure modes can include installation-based failure, random failure after installation, and wear out over an extended period of time. Each failure mode can be tracked for multiple luminaires in order to identify the timing and conditions of such failures. For example, once a luminaire has survived for a period after installation, the luminaire can be tracked to determine conditions that contribute to random failure. Random failure can be calculated and expressed in a variety of ways, including mean time to failure (MTTF), which can have units of years, or any other unit of time, in some embodiments.

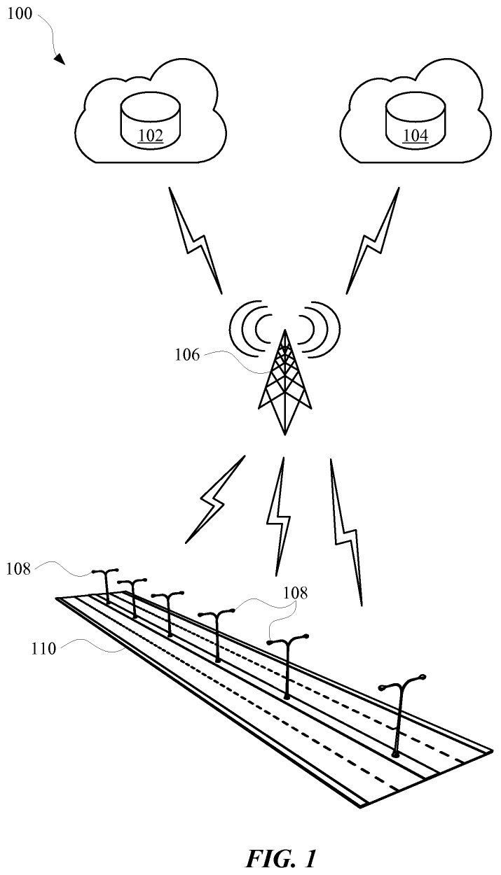

FIG. 1 illustrates a system 100 for communicating data that can be used to develop predictions of luminaire lifetimes. Luminaires 108 can be installed at numerous different locations in order to provide light for a variety of purposes such as navigating and working. When luminaires 108 are installed along streets 110, their locations can be far from populous areas, making them difficult to maintain. Maintenance of the luminaires 108 can involve scheduling transportation of equipment to such locations, which can be inefficient and costly when luminaires 108 randomly fail or otherwise malfunction. However, the system 100 is capable of providing luminaire lifetimes predictions so that luminaire maintenance can be planned and coordinated in a more efficient manner.

The system 100 can include a network of luminaries 108 that each include a diagnostic module for tracking data related to environmental conditions of each luminaire 108. The diagnostic module can be a hardware and/or software element of a computing device that is part of the luminaire 108. The diagnostic module can include one or more sensors that can measure temperature, humidity, wind speeds, sound, vibration, power grid properties, radiation, air quality, and/or any other metric suitable for use when predicting lifetimes of a device. Data gathered from the operation of the sensors can be stored in a memory of the luminaire 108 and/or transmitted to a remote device.

Additionally, each luminaire 108 can communicate over a network connection 106 with one or more remote devices capable of analyzing the data measured by the diagnostic modules and/or environmental data related to conditions of the luminaires 108. For example, one or more luminaires 108 can be connected to a lighting management device 102 that can include or be connected to a database that stores data collected by the diagnostic modules of the luminaires 108. The lighting management device 102 can be a computing device that tracks data affecting lifetimes the luminaires 108 in order to make predictions regarding when the luminaires 108 will fail. The lighting management device 102 can use the environmental data related to conditions of the luminaires 108 to make these predictions. The environmental data can be transmitted by one or more remote servers 104 tasked with collecting environmental data from a variety of sources. These sources can include weather services, which can provide information regarding weather conditions near and far from the luminaires 108. For example, the weather services can provide data related to conditions external to the luminaires 108 such as maximum temperature, mean temperature, minimum temperature, humidity, cloud coverage, percentage of sunshine, precipitation, chances of thunder, chances of lightning, condensation, heat index, vapor pressure, air quality, saltiness of air, wind speed, and/or any other data that can affect an operation of an outdoor device.

The lighting management device 102 can calibrate and/or correlate data from the diagnostic modules of the luminaires 108 and the remote servers 104. By calibrating the data from the diagnostic modules with data from the remote servers 104, predictions can be made about the lifetime of the diagnostic modules and the luminaires 108. For example, each diagnostic module can include a temperature sensor for tracking a temperature of each luminaire 108. Temperature data from the diagnostic module can be calibrated with temperature data from the remote servers 104 to develop a correlation function so that when the diagnostic module fails, the temperature of the luminaire 108 can be extrapolated. The extrapolated data, in combination with environmental data, can then be used as a basis for predicting when the luminaire 108 will fail or otherwise malfunction. The correlation function can be based on statistical analysis, machine learning, linear analysis, and/or any other technique for identifying correlations between two or more sets of data.

Failures of the luminaires 108 can occur at different phases of the each luminaire's lifetime. The lighting management device 102 can store multiple different algorithms for predicting luminaire lifetimes according to how long the luminaires have been installed. For example, failures can be categorized at least as installation-based failures, random failure, and/or wear out failures. Installation-based failures can correspond to failures that occur within a time period that begins at installation, random failures can correspond to failures that occur within a range of time after installation and before the end of a full lifetime, and wear out failures can correspond to failures that occur as a result of wear out from operations occurring over the full lifetime. A full lifetime can be a length of the luminaire survives without experiencing installation-based and/or random failure. Failures that occur according to the described categories can be influenced by different environmental factors, therefore algorithms that use to the environmental factors to predict luminaire lifetimes can be developed for each category. For example, installation-based failure can be influenced by power grid data, therefore an algorithm that predicts installation-based failure of luminaires 108 can be based on a correlation between power grid data and local electrical data from each luminaire's diagnostic module. Furthermore, random failure (i.e., failure between installation-based failure and wear out) can be influenced by weather related data. Therefore, an algorithm for predicting random failure of luminaires 108 can be based on a correlation between the weather related data provided by the luminaires 108 and remote server 104.

Algorithms for predicting luminaire lifetimes can be ranked over time in order to improve the prediction capabilities of the lighting management system 102. Additionally, algorithms can be ranked according to their ability to predict luminaire lifetimes in certain geographic locations. For example, some algorithms can be better at predicting luminaire lifetimes in humid environments than other algorithms. Alternatively, algorithms can be ranked according to their ability to predict luminaire lifetimes at different periods of time. For example, some algorithms can be better at predicting luminaire lifetimes during certain months or seasons than other algorithms. The lighting management device 102 can therefore select algorithms according to a geographic region in which the luminaire 108 is operating, or a time period in which the algorithm is providing lifetime predictions for.

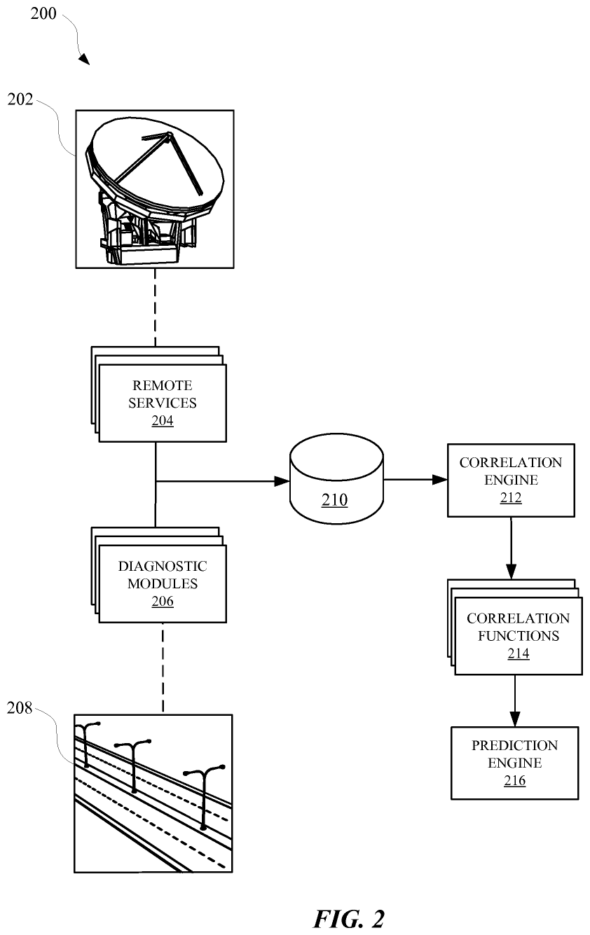

FIG. 2 illustrates a lighting management system 200 for collecting data related to operations of luminaires and using the data to develop correlation functions for extrapolating sensor data when sensors of the luminaires fail. The lighting management system 200 can include remote services 204 that can operate separately from the luminaires to collect data associated with an environment in which the luminaires are operating. For example, the remote services 204 can correspond to applications that use information from a weather dish 202 to track weather data for a variety of different clients. Data collected by the remote services 204 can be provided to a database 210 of the lighting management system 200.

The lighting management system 200 can further include diagnostic modules 206 that are embedded in luminaires dispersed over a variety of locations in a geographic area. For example, the luminaires corresponding to the diagnostic modules 206 can include a network of luminaires 208 located along streets in the geographic area. The diagnostic modules 206 can be embodied as hardware and/or software operating on the luminaires, and each diagnostic module 206 can include one or more sensors for collecting data related to the operation of a luminaire. Specifically, the one or more sensor of each diagnostic module 206 can measure internal and external features of a luminaire and cause the luminaire to transmit any data collected from the sensors to the database 210. In this way, the database 210 can include information related to an internal environment and an external environment of each luminaire.

The lighting management system 200 can also include a correlation engine 212 that can identify correlations between the environmental data provided by the remote services 204 and the local luminaire data provided by the diagnostic modules 206. The correlations can then be used to develop correlation functions 214, which can be used to extrapolate sensor data for a sensor of a diagnostic module that has malfunctioned or is otherwise inoperable. The correlation engine 212 can operate according to one or more algorithms for identifying patterns and/or trends in data. For example, the correlation engine 212 can operate according to one or more machine learning algorithms.

In some embodiments, the correlation engine 212 can employ a Hidden Markov Model for creating one or more functions that can be used to extrapolate sensor data when a sensor of a diagnostic module 206 fails. The Hidden Markov Model can use observable outputs from the remote services 204 and the diagnostic modules 206 to infer a sequence of states that are at least partially responsible for causing the outputs. The sequence of states can thereafter be used to predict outputs from a diagnostic module 206 that has a failed sensor. The derivation of the predictions can be embodied in one or more correlation functions 214 stored by the lighting management system 200. In other embodiments, a Recurrent Neural Network can be employed for creating a correlation function 214 to extrapolate sensor data. The Recurrent Neural Network can use one or more vector inputs, corresponding to the data from the remote services 204 and the diagnostic modules 206, to develop the correlation function 214. The Recurrent Neural Network can include (e.g., be trained using labeled instances of) previous vector inputs for comparison with the incoming vector inputs, and allows for multidirectional flow between neurons of the Recurrent Neural Network. A resulting trained Recurrent Neural Network can thereafter be used as a correlation function 214 for extrapolating sensor data when a sensor of a diagnostic modules 206 has failed.

In other embodiments, machine learning algorithms that use some amount of pre-processing of inputs can be employed by the correlation engine 212. For example, in some embodiments, a Decision Tree Algorithm can be used by the correlation engine 212. Pre-processing for the Decision Tree Algorithm can involve identifying domains or ranges of the inputs from the remote services 204 and the diagnostic modules 206. Once the domains and/or ranges have been identified for purposes of creating classifications, the Decision Tree Algorithm can be executed as a correlation function 214 for extrapolating sensor data. In other embodiments, a Random Forest Algorithm can be used for extrapolating sensor data when a sensor fails. Pre-processing for the Random Forest Algorithm can be performed by constructing multiple decision trees that are trained on randomly sampled data and variables. Once the decision trees are constructed, the Random Forest Algorithm can be used to make predictions about sensor data after one or more sensors have failed.

In yet other embodiments, algorithms for extrapolating sensor data after a sensor fails can be developed under the assumption that there will be a non-linear relationship between the remote services 204 data and the diagnostic module 206 data. For example, a Support Vector Machine algorithm can be used to perform non-linear classification on data from the remote services 204 and the diagnostic modules 206. Alternatively, Ensemble Learning or Deep Learning can be used to perform non-linear classification of inputs. Ensemble Learning can combine a variety of different learning models in order to perform non-linear classification of data from the remote services 204 and the diagnostic modules 206.

Algorithms for extrapolating sensor data after a sensor fails can also be developed under the assumption that there will be a linear relationship between the remote services 204 data and the diagnostic modules 206 data. For example, a Linear Regression algorithm can be used by the correlation engine 212 to generate one or more correlation functions 214 for extrapolating sensor data once a sensor has stopped operating. A Linear Regression algorithm can use at least one input to make predictions about what an output will be. For example, Linear Regression can be employed by the correlation engine 212 to use the data from the remote services 204 to make predictions about how the data from the diagnostic modules 206 changes over time. In yet other embodiments, a lasso regression and stochastic gradient descent algorithm can be used. Under the lasso regression and stochastic gradient descent algorithm, randomly selected values from training sets can be used to create gradient boundaries for classifying data and essentially training a neural network. This algorithm is useful for training a neural network from large amounts of data. Once trained, the neural network can be used as a correlation function 214 for extrapolating sensor data after one or more sensors of the diagnostic modules 206 have failed.

Once one or more correlation functions 214 have been generated by the lighting management system 200, outputs from the correlation functions 214 can be supplied to a prediction engine 216. In this way, the prediction engine 216 is able to make predictions about luminaire lifetimes using extrapolated sensor data generated by a correlation function 214 after one or more sensors have failed. The prediction engine 216 can be in communication with the database 210 and also receive data collected from the remote services 204. As a result, data, such as number of weather cycles, can be used in combination with the output from one or more correlation functions 214 to estimate luminaire lifetimes.

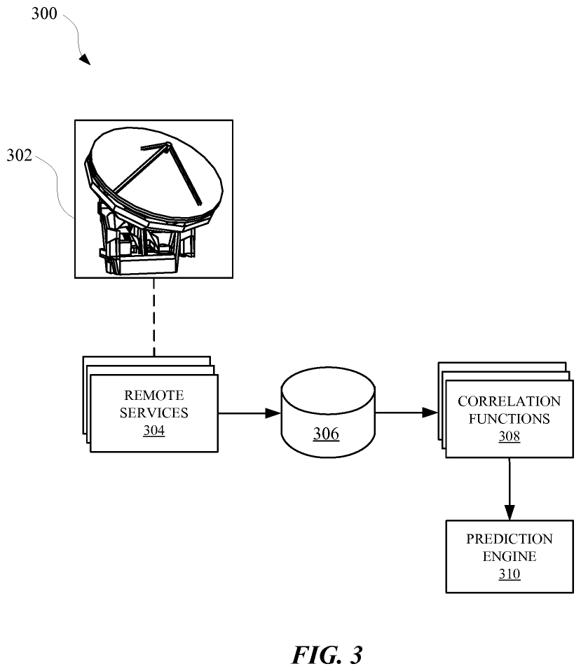

FIG. 3 illustrates a lighting management system 300 that uses one or more correlation functions 308 to provide extrapolated sensor data when one or more sensors of the lighting management system 300 has failed or are otherwise inoperable. The lighting management system 300 can include the same features as lighting management system 200, except that lighting management system 300 does not include every diagnostic modules from lighting management system 200. Rather, the lighting management system 300 uses correlation functions 308 to extrapolate sensor data that would otherwise be available from the diagnostic modules. The extrapolated sensor data can then be used by a prediction engine 310 to generate estimates of luminaire lifetime for each luminaire in a network of luminaires that are in communication with the lighting management system 300.

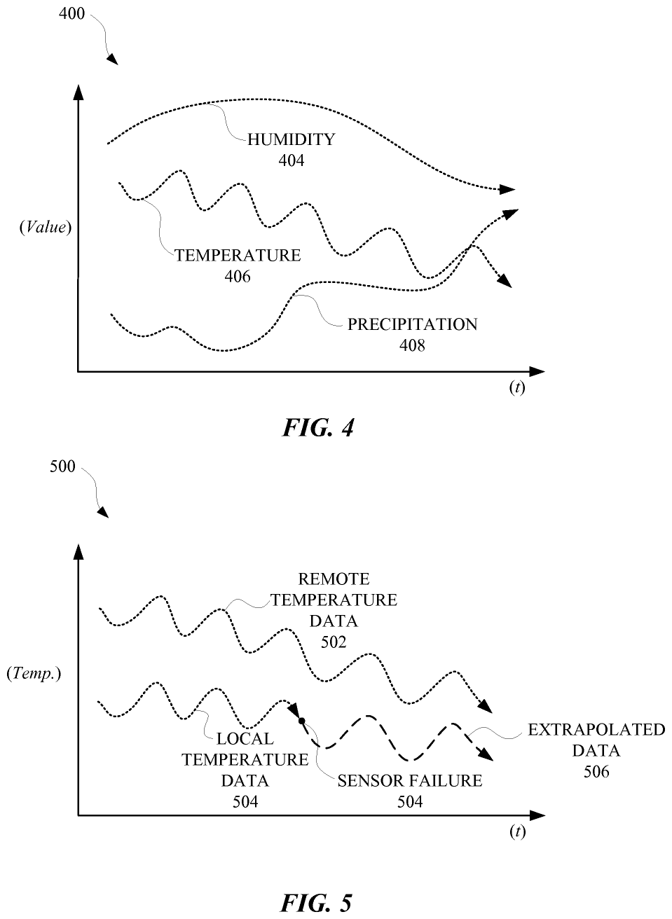

The lighting management system 300 can include a database 306 that receives data from remote services 304 that measure environmental features of an operating environment of the luminaires. The database 306 can store data previously provided by one or more sensors that are embedded in each luminaire of the network of luminaires. The data provided by the remote services 304 after one or more sensors have failed can be used by the correlation functions 308 to extrapolate sensor data, despite any new sensor data being unavailable. The correlation functions 308 can be based on one or more statistical and/or machine learning algorithms. The extrapolated sensor data and/or the data from the remote services 304 can be used by the prediction engine 310 to estimate lifetimes for the luminaires of the network of luminaires. In this way, corrective and/or predictive maintenance can be performed despite their being limited information coming directly from the luminaires. FIG. 4 illustrates a plot 400 of a variety of variables that can be collected by the remote services discussed herein. Specifically, plot 400 illustrates example data that can correspond to environmental variables measured by the remote services. For example, plot 400 can include humidity data 404 over a period of time (“t”), temperature data 406 over a period of time, and precipitation data 408 over a period. The values (“Values”) for this data can have some relationship to sensor data provided by sensor embedded in luminaires that are located proximate to where the remote services are measuring the data. For example, as provided in plot 500 of FIG. 5, remote temperature “(Temp.)” data 502 collected by a remote service can have some correlation to local temperature data 504 measured by a sensor of a diagnostic module of a luminaire. The correlation can be identified by a correlation engine, which can be embodied as software operating on a device of a lighting management system. The correlation can be approximately a one to one correlation in some cases. However, because the generation of local temperature measurements can depend on whether a sensor is on or off, the correlation engine can identify patterns of when the luminaire is on or off. Therefore, luminaire lifetime predictions can also be based on patterns related to when the luminaire is on or off. Furthermore, correlations can be based on data taken from a local sensor and multiple remote sensors of different types. The correlation engine can convert one or more correlations into a correlation function whose input is the data from the remote service and whose output is extrapolated data 506. The extrapolated data 506 can be generated after there has been a sensor failure 504. The extrapolated data 506 can be used by a prediction engine to make predictions about how long a luminaire will be operational so that maintenance can be scheduled when the luminaire stops being operational. In some embodiments, one or more other variables can be used to identify correlations between remote services data and sensor data. For example, humidity data 404 can be provided by a remote service, while a sensor of a luminaire also measures humidity. A correlation function corresponding to the humidity data can be derived so that, after a humidity sensor of the luminaire fails, the correlation function can be used thereafter to generate sensor data.

Data can be collected by a database of a lighting management system that relates the remote services data and/or the sensor data to luminaire lifetimes. The data can be analyzed by the lighting management system to determine trends in luminaire lifetimes compared to the data in the database. For example, a prediction engine of the lighting management system can determine that a luminaire will fail after a threshold number of temperature cycles have occurred at the luminaire. The number of temperature cycles can be tracked using sensor data from the luminaire, and from extrapolated sensor data generated after the sensor has failed. Alternatively, the prediction engine of the lighting management system can determine that the luminaire will fail after experiencing a threshold amount of humidity for at least a particular period of time. The humidity experienced by the luminaire can be tracked using the sensor data from the luminaire, and from extrapolated sensor data generated after the sensor has failed. Once the luminaire has experienced the threshold number of temperature cycles and/or the threshold amount of humidity, the lighting management system can provide an indication to a maintenance system for the luminaire so that maintenance can be scheduled and/or performed.

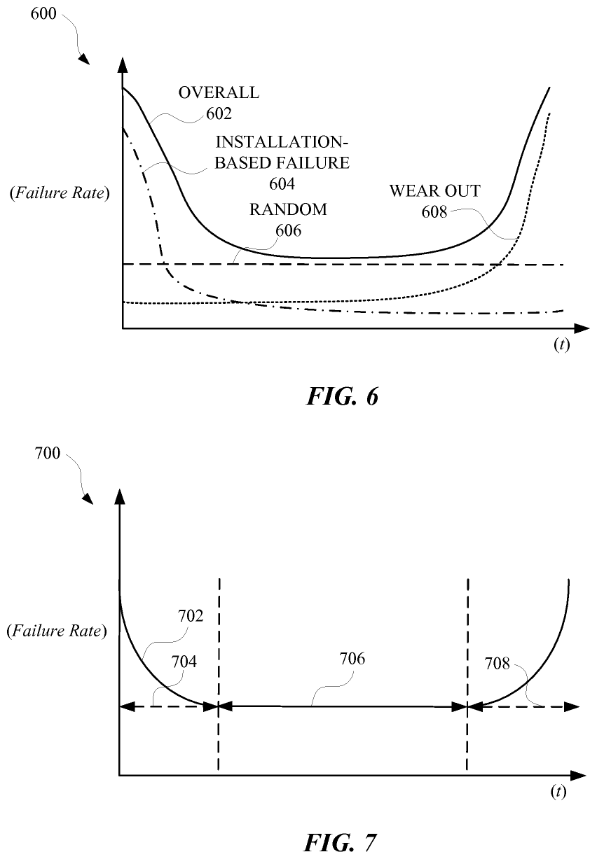

FIG. 6 illustrates a plot 600 of different failures rates that correspond to different types of failures that can occur at a network of luminaires. In some embodiments, a lighting management system can track the occurrence of different types of failures in order to accurately make predictions about when a luminaire of the lighting management system will fail. For example, the plot 600 can include failure rate data corresponding to installation-based failure 604. Installation-based failure can correspond to a time period that includes the installation of a luminaire. During installation and immediately after installation, a luminaire can be more susceptible to certain types of environmental influences, such as conditions related to a power grid. Therefore, a prediction engine of the lighting management system can use power grid data to make estimates about luminaire lifetime during a range of time that includes the initial installation. In other words, the prediction engine can determine how long the luminaire has been in operation and then select the data or function corresponding to the amount of time the luminaire has been installed before making a prediction about the lifetime of the luminaire.

The plot 600 can also include a random failure rate 606 and a wear out rate 608. The random failure rate 606 can correspond to failures that occur without any relationship to the operational lifetime of the luminaire, but otherwise contribute to the overall failure rate 602 of the luminaire. The wear out rate 608 can correspond to failures that can occur as a result of degradation caused by regular use of the luminaire. The prediction engine can predict lifetimes of luminaires according to the random failure rate 606 and/or wear out rate 608. For example, the prediction engine can predict lifetimes for luminaires based at least partially on the random failure rate 606, regardless of the operational lifetimes of the luminaires. Furthermore, the prediction engine can identify data that contributes to wear out failure rate 608 when making predictions about luminaire lifetimes. For example, temperature and humidity can contribute to wear out failure rates 608. Therefore, extrapolated sensor data, corresponding to sensor data acquired after a sensor has failed, can be used as a basis for predicting luminaire lifetimes after installation of the luminaires.

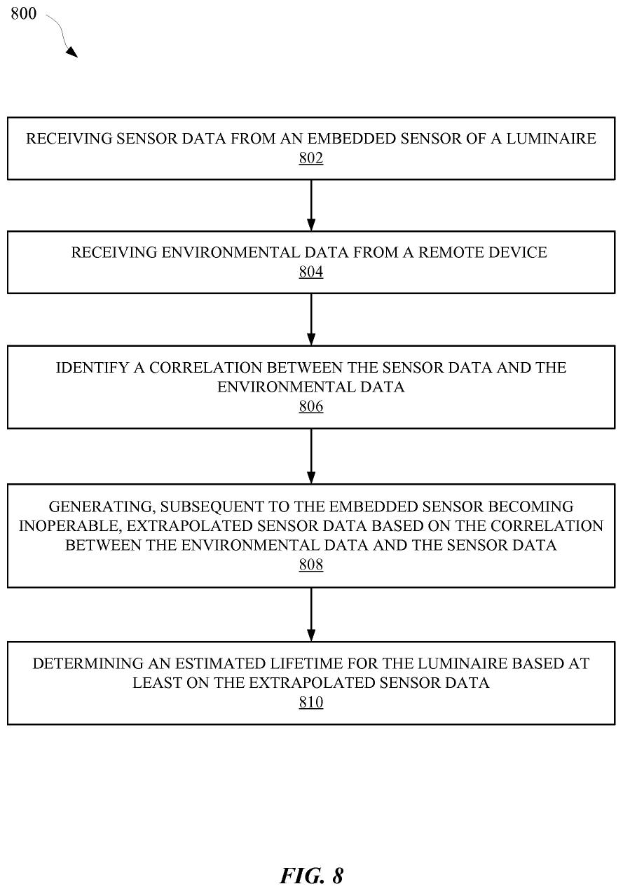

FIG. 7 illustrates a plot 700 that includes time ranges that can be stored or otherwise accessible to a lighting management system. The plot 700 can include a trend line 702 corresponding to a failure rate for one or more luminaires that are in communication with the lighting management system. The trend line 702 can be based on data collected about the lifetime of similar luminaires. The lighting management system can use the data to identify time ranges corresponding to certain types of luminaire failures. For example, time range 704 can correspond to a time when installation-based failure rate can be most prominent. During this time, the prediction engine of the lighting management system can use data related to conditions that most influence installation-based failure to predict how long a luminaire will be operational. Furthermore, time range 706 can correspond to a time period after installation and before the end of a normal lifetime for a luminaire when the luminaire can succumb to random failure. Time range 708 can correspond to a time period that includes the end of a normal lifetime for a luminaire when the luminaire can fail as a result of wear out. During time range 706 or time range 708, a prediction engine of the lighting management system can select data that corresponds to environmental data that can influence random failure or wear out, respectively. The selected environmental data can then be used to make predictions about how long the luminaire will remain operational.

FIG. 8 illustrates a method 800 for estimating a lifetime of a luminaire based on extrapolated sensor data. The method 800 can be performed by a lighting management system, a luminaire, a computing device, and/or any other apparatus suitable for analyzing data related to a luminaire. The method 800 can include a block 802 of receiving sensor data from an embedded sensor of a luminaire. The luminaire can be part of a network of luminaires that are in communication with each other and distributed over a geographic area. The method 800 can further include a block 804 of receiving environmental data from a remote device. The remote device can be a remote computing device that tracks environmental data using one or more remote services. For example, the remote device can access a weather service that provides data related to temperature, humidity, precipitation, and/or any other weather metric related to an operating environment of the luminaire.

The method 800 may further include a block 806 of identifying a correlation between the sensor data and the environmental data, as described previously. The method 800 can further include a block 808 of generating extrapolated sensor data after the embedded sensor has become inoperable. The extrapolated sensor data can be based on a correlation between environmental data and the sensor data. Furthermore, the correlation can be identified using a machine learning algorithm or other statistical algorithm. At block 810, an estimated lifetime for the luminaire can be determined based at least on the extrapolated sensor data. The estimated lifetime can be a mean time to failure and can be used for scheduling maintenance of one or more luminaires in the future.

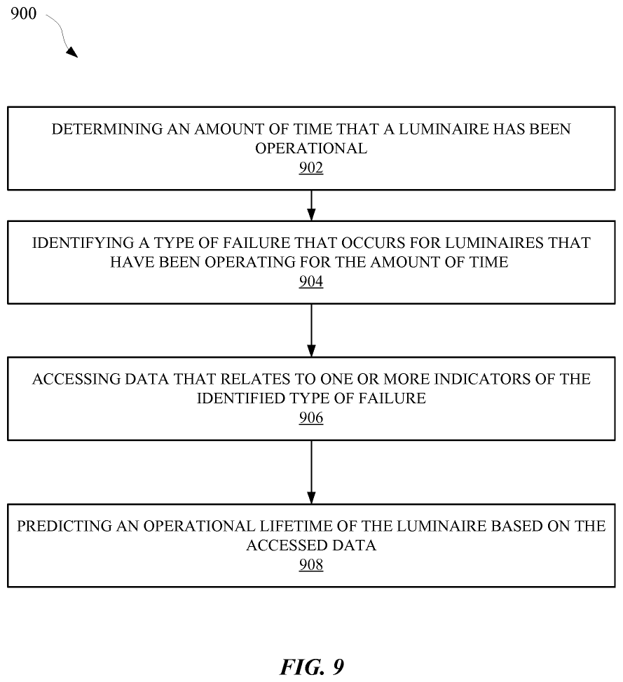

FIG. 9 illustrates a method 900 for estimating a lifetime of a luminaire based on how long the luminaire has been operational. The method 900 can be performed by a lighting management system, a luminaire, a computing device, and/or any other apparatus suitable for analyzing data related to a luminaire. The method 900 can include a block 902 of determining an amount of time that a luminaire has been operational. For example, the amount of time can be less than a week when the luminaire has only recently been installed, or the amount of time can be more than ten years if the luminaire has survived a considerable amount of time after installation. The method 900 can further include a block 904 of identifying a type of failure that occurs for luminaires that have been operating for the amount of time. The type of failure can be installation-based failure, random failure, wear out, and/or any other type of failure. Furthermore, the type of failure can be identified based on whether it is the most frequent type of failure for luminaires having the determined amount of time in operation. At block 906, data that relates to one or more indicators of the identified type of failure can be accessed. For example, power grid data can be more influential on installation-based failure than temperature data, and temperature data can be more influential on wear out than power grid data. Furthermore, the data can be extrapolated from previously recorded sensor data according to any of the embodiments discussed herein. At block 908, a prediction of operational lifetime for the luminaire can be made based on the accessed data. The prediction can be used to schedule future maintenance for the luminaire. While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope.

1. A method for extrapolating data after a sensor of a first device ceases to provide data, the method comprising:
receiving first data from the sensor of the first device, the first data comprising a temperature of the first device;
receiving second data from a remote device, wherein the second data corresponds to measurements associated with an operational environment of the first device, the second data comprising environmental data;
identifying, using one or more processors, a correlation between the first data and the second data; and
generating, using one or more processors, subsequent to the sensor ceasing to provide data, extrapolated data based on a correlation between the first data and the second data, and
determining an estimated lifetime for the first device based at least on the extrapolated data.

2. The method of claim 1, wherein the extrapolated data is generated according to a machine learning algorithm.

3. The method of claim 2, wherein the machine learning algorithm is used to derive a correlation function, and generating the extrapolated data includes:
providing the second data as an input to the correlation function, which outputs the extrapolated data in response to receiving the second data.

4. The method of claim 2, wherein the machine learning algorithm includes a step of generating a decision tree for categorizing the first data received from the sensor.

5. The method of claim 1, wherein determining the estimated lifetime for the device includes comparing the extrapolated data to collected data that is associated with a different device that was previously rendered inoperable.

6. The method of claim 1, wherein determining the estimated lifetime for the device includes determining an amount of the time the device has been operational, and identifying a type of device failure that is associated with the amount of time.

7. The method of claim 1, wherein the sensor is a temperature sensor, the extrapolated data is predicted temperature data, and the estimated lifetime for the device is determined at least partially based on a number of temperature cycles experienced by the device as indicated by the predicted temperature data and the first data.

8. The method of claim 1, wherein the extrapolated data is also generated prior to the sensor ceasing to provide the first data, and the sensor is temporarily shutdown to stop the sensor from providing the first data.

9. A lighting management system, comprising:
a luminaire that includes a sensor for measuring an operating condition of the luminaire, the operating condition comprising a temperature of the luminaire,
a memory configured to store sensor data received from the sensor of the luminaire and environmental data received from a remote device that tracks environmental conditions associated with the luminaire; and
a processor in communication with the luminaire and the memory, the processor configured to identify a correlation between the sensor data and the environmental data, and use the correlation to generate extrapolated sensor data for storage in the memory after the sensor ceases to provide the sensor data, wherein the processor is further configured to determine an estimated lifetime of one or more components of the luminaire using at least the extrapolated sensor data.

10. The lighting management system of claim 9, wherein the processor is further configured to identify the correlation using a machine learning algorithm that involves pre-processing the environmental data for identifying statistical features of the environmental data.

11. The lighting management system of claim 9, wherein the sensor is a temperature sensor that measures an internal temperature of the luminaire and the environmental data corresponds to an external temperature of the luminaire.

12. The lighting management system of claim 9, wherein the environmental data corresponds to an environmental variable having different units than the sensor data.

13. The lighting management system of claim 9, wherein the processor is further configured to use a statistical regression algorithm for identifying the correlation between the sensor data and the environmental data.
